(19) United States
(12) Patent Application Publication
(10) Pub. No.: US 2003/0077412 A1
(43) Pub. Date: Apr. 24, 2003

(54) Adhesive tape

(76) Inventor: Chung-Chin Wang, Taoyuan (TW)

Correspondence Address: BIRCH STEWART KOLASCH & BIRCH, PO BOX 747, FALLS CHURCH, VA, 22040-0747, US

(21) Appl. No.: 09/981,917

(22) Filed: Oct. 19, 2001

(51) Int. Cl. B32B 7/06

(52) U.S. Cl. 428/40.1; 428/77

(57) ABSTRACT

An adhesive tape is proposed, including a peeled-off layer having its first surface formed with a plurality of protruding portions, and an adhesive layer formed on a second surface of the peeled-off layer and dimensioned to be smaller in surface area than the peel-off layer. With the provision of the protruding portions, when the adhesive tape is rolled up in disk-like shape, the adhesive layer in an outer part is only adhered to the protruding portions of the peel-off layer in an inner part, without forming surface-to-surface contact with the first surface of the peel-off layer in the inner part of the rolled adhesive tape. This therefore eliminates the use of a release agent on the peel-off layer, thereby reducing the fabrication cost and improving usage convenience.

### FIELD OF THE INVENTION

The present invention relates to adhesive tapes, and more particularly, to an adhesive tape, which can be adhered to an open end of a bag and used to seal up the bag in a peeling open/sealing close manner repeatedly.

### BACKGROUND OF THE INVENTION

As shown in FIG. 1, a conventional adhesive tape 1 includes an adhesive layer 100 for being adhered to an open end of a bag, and two peel-off layers 111, 112 respectively attached to upper and lower surfaces of the adhesive layer 100. Between the adhesive layer 100 and the two peel-off layers 111, 112 there are respectively applied release agent layers 121, 122, so as to allow the peel-off layers 111, 112 to be easily peeled off from the adhesive layer 100, and thus the bag can be repeatedly opened and closed in the use of the adhesive tape 1.

However, due to the provision of the two peel-off layers 111, 112, the adhesive tape 1 is rolled up in disk-like shape with significant increase in diametric thickness, and also the fabrication cost is increased. As shown in FIG. 1B, when the adhesive tape 1 is rolled up in disk-like shape, since the peel-off layer 112 in an outer part A′ is not adhesive to the adjacent peel-off layer 111 in an inner part B′, thus the shape of the rolled adhesive tape 1 is hardly maintained without using any supporting element. As such, a disk-shaped supporting element (not shown) is usually employed at both sides of the adhesive tape 1, so as to help roll up the adhesive tape 1 and keep the rolled adhesive tape 1 in shape. This therefore causes inconvenience in fabrication and increases the fabrication cost for the use of the supporting element.

In order to minimize the fabrication cost and to avoid the use of double peel-off layers, Taiwanese Utility Model Patent No. 089215726 discloses an adhesive tape with only one peel-off layer. This adhesive tape includes: a peel-off layer having a first surface and a second surface; a first release agent layer coated on the first surface of the peel-off layer; a second release agent layer coated on the second surface of the peel-off layer; and an adhesive layer attached to the first release agent layer, for being adhered to a surface of an external object. The adhesive tape is characterized in that adhesion force between the first release agent layer and the adhesive layer is greater than that between the second release agent layer and the adhesive layer, and adhesion force between the adhesive layer and the surface of the external object is greater than that between the adhesive layer and the first release agent layer. Hence, when the adhesive tape is rolled up in disk-like shape, the adhesive layer in an outer part can be adhered to the second release agent layer in an inner part, and thus the rolled adhesive tape can be maintained in shape. Also, when the outer part of the rolled adhesive tape is to be peeled off from the inner part, due to the adhesion force between the adhesive layer and the first release agent layer is greater than that between the adhesive layer and the second release agent layer, the adhesive layer stays firmly attached to the first release agent layer in the peeled outer part, without being left as adhered to the second release agent layer in the inner part. However, since a release agent is essentially applied on both surfaces of the peel-off layer, decrease in fabrication cost of the adhesive tape is limited.

Moreover, another adhesive tape having only one peel-off layer without any release agent coating is available. As shown in FIG. 2, the peel-off layer of this adhesive tape is corrugated with its cross section formed in continuous wave shape. Thus, when the adhesive tape is rolled up, an adhesive layer of the adhesive tape in an outer part is partially adhered to the peel-off layer in an inner part. However, since the peel-off layer is corrugately formed, its usage length is significantly increased. Also, in order to maintain the peel-off layer in shape, the thickness of the peel-off layer needs to be increased for preventing the layer from flattening out, or alternatively, the peel-off layer is necessarily formed in shape by performing a particular shaping process, which further increases the fabrication cost. Moreover, since adhesion area between the corrugated peel-off layer and the adhesive layer is significantly reduced, the adhesive layer usually needs to be increased in its adhesion force, so as to assure the sufficient adhesion between the peel-off layer and the adhesive layer. This therefore increases the fabrication cost, and makes the peel-off layer more hardly to be removed from the adhesive layer.

In addition, for all the adhesive tapes described above, the adhesive layers thereof are entirely attached to and completely cover the peel-off layers. After the adhesive tape is adhered via the adhesive layer to an object such as a plastic bag, it occurs that the peel-off layer is not easily removed due to an adhesion interface between the peel-off layer and the adhesive layer difficult to be reached by fingers. Also, this usually causes damage to the adhesive layer.

### SUMMARY OF THE INVENTION

A primary objective of the present invention is to provide an adhesive tape, in which the use of a release agent is eliminated, and the fabrication cost can be decreased.

Another objective of the invention is to provide an adhesive tape, in which the use of an adhesive is reduced, and a peel-off layer can be easily removed.

In accordance with the above and other objectives, the present invention proposes an adhesive tape, comprising: a peel-off layer having a first surface and a second surface, and a plurality of protruding portions are formed on the first surface; and an adhesive layer attached to the second surface of the peel-off layer, and dimensioned to be smaller in surface area than the peel-off layer.

The protruding portions can be formed in a regular or random distribution manner with no particular limitation on the vertical height or distribution density, as long as the adhesive layer is only adhered to the protruding portions without forming surface-to-surface contact with the first surface of the peel-off layer. Therefore, when the adhesive tape is rolled up in disk-like shape, adhesion area between the second surface of the peel-off layer and the adhesive layer in an outer part is greater than that between the adhesive layer in the outer part and the first surface of the peel-off layer in an inner part of the rolled adhesive tape.

### BRIEF DESCRIPTION OF THE DRAWINGS

The present invention can be more fully understood by reading the following detailed description of the preferred embodiments, with reference made to the accompanying drawings, wherein:

FIG. 1A (PRIOR ART) is a sectional view of a conventional adhesive tape;

FIG. 1B (PRIOR ART) is a sectional view of a conventional adhesive tape in FIG. 1A after being rolled up;

FIG. 2 (PRIOR ART) is a sectional view of another conventional adhesive tape;

FIG. 3 is a front view of an adhesive tape of the invention;

FIG. 4 is a sectional view of FIG. 3 cutting along a line A-A;

FIG. 5 is a partially magnified sectional view of an adhesive tape of the invention after being rolled up in disk-like shape;

FIG. 6 is a sectional view of an adhesive tape of the invention being adhered to an open end of a bag; and

FIG. 7 is a sectional view of removing a peel-off layer of FIG. 6.

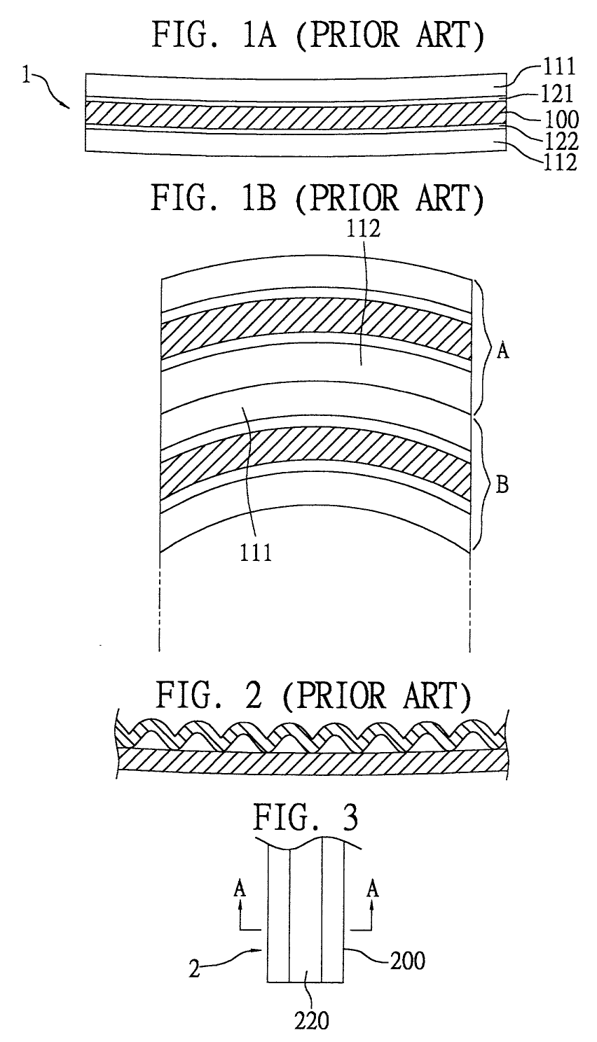

### DETAILED DESCRIPTION OF THE PREFERRED EMBODIMENTS

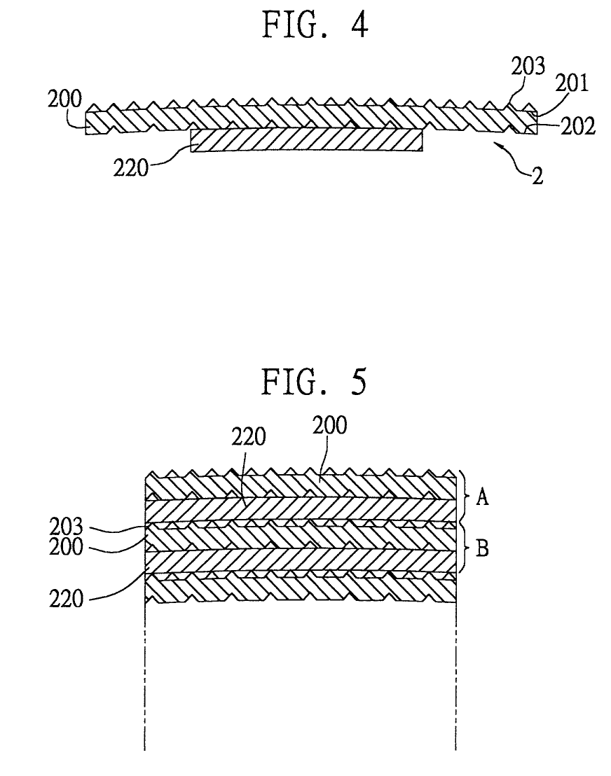

Illustrated in FIGS. 3 and 4 are an adhesive tape 2 of one embodiment of the present invention, comprising: a peel-off layer 200 having a first surface 201 and a second surface 202, and a plurality of protruding portions 203 protruding upwardly are formed on the first surface 201 of the peel-off layer 200; and an adhesive layer 220 attached to the second surface 202 of the peel-off layer 200, and dimensioned to be smaller in surface area than the peel-off layer 200. In this embodiment, the adhesive layer 220 is formed at a middle position of the peel-off layer 200 in a manner that, part of the second surface 202 of the peel-off layer 200 is exposed to outside of both sides of the adhesive layer 220.

The peel-off layer 200 is made of a plastic material such as polyethylene (PE) or polypropylene (PP), and adhesion force between the adhesive layer 220 and the peel-off layer 200 needs to be smaller than that between the adhesive layer 220 and a surface of an object such as a plastic bag to be adhered with the adhesive tape 2.

As shown in FIG. 5, when the adhesive tape 2 is rolled up in disk-like shape, the adhesive layer 220 of the adhesive tape 2 in an outer part A is adhered to the protruding portions 203 in an inner part B, instead of being directly adhered onto the first surface 201 of the peel-off layer 200 in the inner part B. This makes the rolled adhesive tape 2 stay in shape, and the outer part A can easily be detached from the inner part B, without the occurrence of part of the adhesive layer 220 in the outer part A being left as adhered to the first surface 201 of the peel-off layer 200 in the inner part B during removing the adhesive layer 220 from the protruding portions 203. That is, since the protruding portions 203 are interposed between the adhesive layer 220 in the outer part A and the peel-off layer 200 in the inner part B, and the adhesive layer 220 is only adhered in small area to the protruding portions 203, thus the adhesive layer 220 does not come into surface-to-surface contact with the first surface 201 of the peel-off layer 200, and the adhesive layer 220 can remain intact with its adhesion force in no use of a release agent on the peel-off layer 200. Moreover, since there is still roughly surface-to-surface adhesion between the adhesive layer 220 and the peel-off layer 200, the adhesion is sufficiently strong with no need of increasing adhesion force of the adhesive layer 220.

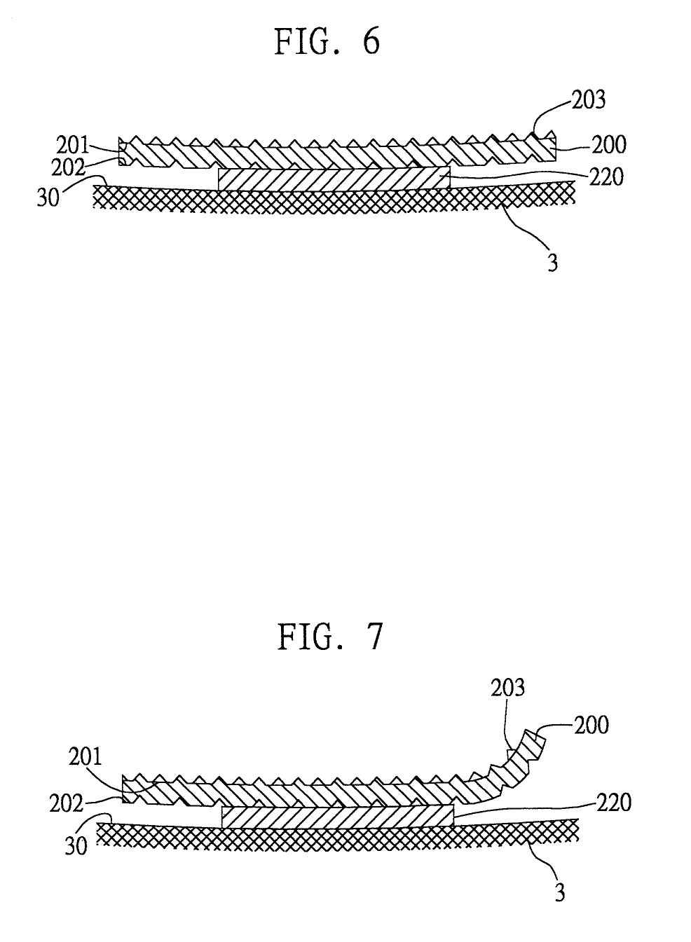

As shown in FIG. 6, when the adhesive tape 2 is used to seal up an open end of a plastic bag 3, the adhesive layer 220 of the adhesive tape 2 is attached to a surface 30 of the open end of the plastic bag 3, with the peel-off layer 200 adhered to the adhesive layer 220. Then, as shown in FIG. 7, during removing the peel-off layer 200 from the adhesive layer 220, since adhesion force between the adhesive layer 220 and the surface 30 of the plastic bag 3 is greater than that between the peel-off layer 200 and the adhesive layer 220, thus the adhesive layer 220 can stay in position on the surface 30 of the plastic bag 3. As a result, only the adhesive layer 220 is left on the plastic bag 3, and then the open end of the plastic bag 3 can be folded inwardly to be sealed to a corresponding position (not shown) of the plastic bag 3 via the adhesive layer 220; this therefore completes the bag sealing process. Further, reopening of the plastic bag 3 can be simply achieved by lifting up the open end thereof for releasing the sealing provided by the adhesive layer 220.

Since the peel-off layer 200 is not adhesive to the surface 30 of the plastic bag 3, and the adhesive layer 220 is dimensionally smaller in surface area than the peel-off layer 200, thus the peel-off layer 200 can be easily removed from the adhesive layer 220 by holding part of the peel-off layer 200 not covered by the adhesive layer 220 for peeling off, so that the adhesive layer 220 can remain intact without being damaged during removing the peel-off layer 200.

Since the peel-off layer 200 and the adhesive layer 220 can be made of conventional materials, they are not further described herein. Further, the adhesive layer 220 can be alternatively formed on one side of the second surface 202 of the peel-off layer 200.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. An adhesive tape, comprising:
a peel-off layer having a first surface and a second surface, wherein a plurality of protruding portions protruding upwardly are formed on the first surface; and
an adhesive layer formed on the second surface of the peel-off layer, for being adhered to a surface of an external object, wherein the adhesive layer is dimensioned to be smaller in surface area than the peel-off layer, and adhesion force between the adhesive layer and the surface of the object is greater than that between the adhesive layer and the peel-off layer.

2. The adhesive tape of claim 1, wherein the peel-off layer is made of polyethylene.

3. The adhesive tape of claim 1, wherein the peel-off layer is made of polypropylene.

4. The adhesive tape of claim 1, wherein the adhesive layer is formed at a middle position of the second surface of the peel-off layer.

5. The adhesive tape of claim 1, wherein the adhesive layer is formed on one side of the second surface of the peel-off layer.

6. The adhesive tape of claim 1, wherein the second surface of the peel-off layer forms surface-to-surface adhesion to the adhesive layer.

7. The adhesive tape of claim 1, wherein when the adhesive tape is rolled up in disk-like shape, adhesion area between the second surface of the peel-off layer and the adhesive layer in an outer part is greater than that between the adhesive layer in the outer part and the first surface of the peel-off layer in an inner part of the rolled adhesive tape.
